(19) United States
(12) Patent Application Publication
(10) Pub. No.: US 2011/0161145 A1
(43) Pub. Date: Jun. 30, 2011

(54) METHOD AND DEVICE FOR SECURELY DISPLAYING DIGITAL CONTENT ON A COMPUTING DEVICE

(76) Inventors: Ayeshwarya B. Mahajan, Bangalore (IN); Gyan Prakash, Beaverton, OR (US); Saurabh Dadu, Tigard, OR (US); Ajay Sharma, Bangalore (IN); Neel H. Bhatia, Mumbai (MH); Rajesh Poornachandran, Beaverton, OR (US); Hormuzd Khosravi, Portland, OR (US); K. P. Sameer, Bangalore (IN); Munier Shah, Portland, OR (US)

(21) Appl. No.: 12/647,448

(22) Filed: Dec. 26, 2009

(51) Int. Cl. G06Q 30/00; H04L 9/32; G06F 15/16

(52) U.S. Cl. 705/14.4; 713/176; 709/203; 709/217

(57) ABSTRACT

A method and device for securely displaying digital content, such as an advertisement, on a computing device includes establishing an advertisement enforcement module in a secured environment on the computing device. The computing device receives advertisements from a remote advertisement server, which are validated by the advertisement enforcement module. The advertisement enforcement module ensures that the advertisement is displayed on the computing device in a secure manner and monitors for tampering of the advertisement and advertisement service by the user of the device.

### BACKGROUND

Communication service providers, such as Internet Service Providers (ISPs), are currently offering subscription-based and other subsidized computing devices. The computing devices, which include laptop computers, netbooks, and other mobile computing devices, are typically offered at significant discounts because the cost of the computing device is subsidized based on an end-user subscription agreement and/or advertisement revenue. The communication service providers are able to offer the subsidized computing devices because the service providers retain the ability to control the computing device by “turning off” the communication ability of the computing device should the end user fail to abide by the subscription agreement (e.g., fail to make periodic subscription payments). However, other computing device providers, such as computer retailers, that do not offer or otherwise control such communication services typically do not have the ability to significantly control or otherwise affect the computing devices once purchased by the end-user. As such, subsidization of the cost of the computing device based on an end user subscription or other agreement is financially riskier for such computer retailers and other non-providers of communication services.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of one embodiment of a system for securely displaying digital content on a computing device;

FIG. 2 is a simplified block diagram of a software environment of a computing device and digital content server of the system of FIG. 1;

FIG. 3 is a simplified flow diagram of one embodiment of a method for securely displaying digital content on the computing device of FIG. 2; and

FIG. 4 is a simplified flow diagram of one embodiment of a method for displaying digital content in a reserved display space.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices may be set forth in order to provide a more thorough understanding of the present disclosure. It will be appreciated by one skilled in the art, however, that embodiments of the disclosure may be practiced without such specific details. In other instances, control structures, gate level circuits and full software instruction sequences may have not been shown in detail in order not to obscure the disclosure. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Some embodiments of the disclosure may be implemented in hardware, firmware, software, or any combination thereof. Embodiments of the disclosure implemented in a computer system may include one or more bus-based interconnects between components and/or one or more point-to-point interconnects between components. Embodiments of the invention may also be implemented as instructions stored on a machine-readable, tangible medium, which may be read and executed by one or more processors. A machine-readable, tangible medium may include any tangible mechanism for storing or transmitting information in a form readable by a machine (e.g., a computing device). For example, a machine-readable, tangible medium may include read only memory (ROM); random access memory (RAM); magnetic disk storage media; optical storage media; flash memory devices; and other tangible mediums.

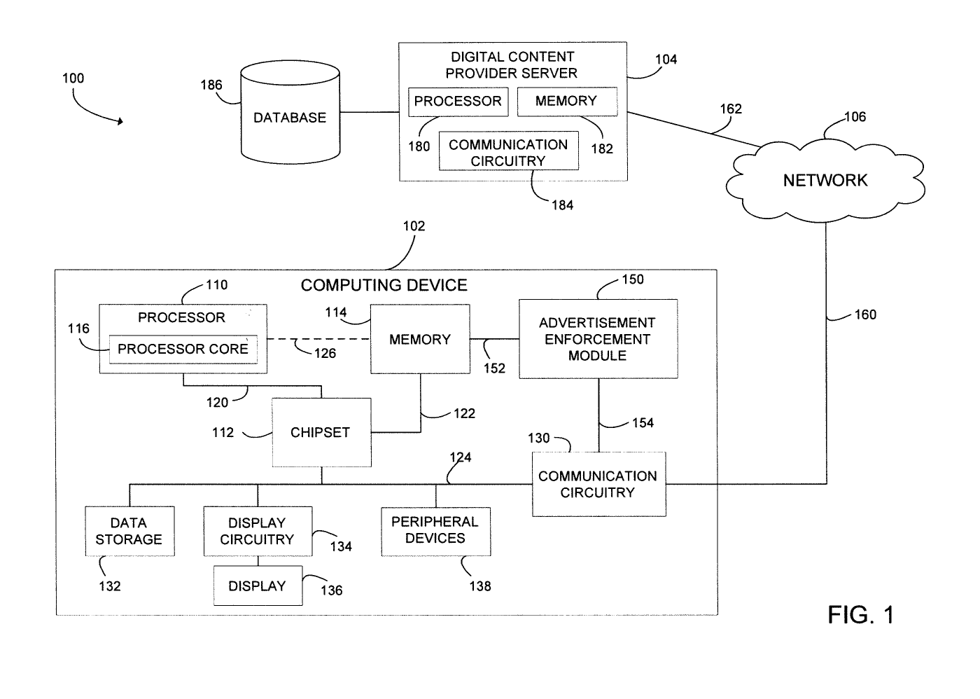

Referring now to FIG. 1, a system 100 for securely displaying digital content, such as digital advertisements, includes a computing device 102 and a digital content provider server 104. The computing device 102 and the digital content provider server 104 are communicatively coupled to each other over a network 106. The network 106 may be embodied as any type of wired and/or wireless network such as a local area network, a wide area network, a publicly available global network (e.g., the Internet), or other network. Additionally, the network 106 may include any number of additional devices to facilitate the communication between the computing device 102 and the digital content provider server 104 such as routers, switches, intervening computers, and the like.

The computing device 102 is configured to receive, and securely display, advertisements from the digital content provider server 104. The computing device 102 may be embodied as any type of computing device capable of performing the functions described herein. For example, in some embodiments, the computing device 102 is embodied as a portable computing device such as a cellular phone, a personal data assistant, a laptop computer, a mobile internet device (MID), or other network-enabled computing device.

The computing device 102 includes a processor 110, a chipset 112, and memory 114. The processor 110 is illustratively embodied as a single core processor having a processor core 116. However, in other embodiments, the processor 110 may be embodied as a multi-core processor having multiple processor cores 116. Additionally, the computing device 102 may include additional processors 110 having one or more processor cores 116. The processor 110 is communicatively coupled to the chipset 112 via a number of signal paths 120. The signal paths 120 may be embodied as any type of signal paths capable of facilitating communication between the processor 110 and the chipset 112. For example, the signal paths 120 may be embodied as any number of bus paths, printed circuit board traces, wires, vias, intervening devices, and/or other interconnects.

The memory 114 may be embodied as one or more memory devices or data storage locations including, for example, dynamic random access memory devices (DRAM), synchronous dynamic random access memory devices (SDRAM), double-data rate synchronous dynamic random access memory device (DDR SDRAM), and/or other volatile memory devices. Additionally, although only a single memory device 114 is illustrated in FIG. 1, the computing device 102 may include additional memory devices in other embodiments.

The chipset 112 may include a memory controller hub (MCH) or northbridge, an input/output controller hub (ICH) or southbridge, and a firmware device. In such embodiments, the firmware device may be embodied as a memory storage device for storing Basic Input/Output System (BIOS) data and/or instructions and/or other information. The chipset 112 is communicatively coupled to the memory 114 via a number of signal paths 122. Similar to the signal paths 120, the signal paths 122 may be embodied as any type of signal paths capable of facilitating communication between the chipset 112 and the memory device 114 such as, for example, any number of bus paths, printed circuit board traces, wires, vias, intervening devices, and/or other interconnects.

In other embodiments, such as embodiments in which the computing device 102 is embodied as a mobile computing device, the chipset 112 may be embodied as a platform controller hub (PCH). In such embodiments, the memory controller hub (MCH) may be incorporated in or otherwise associated with the processor 110. Additionally, in such embodiments, the memory device 114 may be communicatively coupled to the processor 110, rather than the chipset 112 (i.e., rather than the platform controller hub), via a number of signal paths 126. Similar to the signal paths 120, the signal paths 126 may be embodied as any type of signal paths capable of facilitating communication between the memory device 114 and the processor 110 such as, for example, any number of bus paths, printed circuit board traces, wires, vias, intervening devices, and/or other interconnects.

The computing device 102 also includes communication circuitry 130 for communicating with the digital content provider server 104 over the network 106. The communication circuitry 130 may be embodied as any number of devices and circuitry for enabling communications between the computing device 102 and the digital content provider server 104. For example, the communication circuitry 130 may be embodied as one or more wired or wireless network interface cards (NICs) or other network communication cards, modules, or circuits for communicating with the digital content provider server 104 and other remote computing devices (not shown) over the network 106.

The computing device 102 also includes additional peripheral devices such as a data storage 132, a display circuitry 134, and other peripheral devices 138. Each of the communication circuitry 130, the data storage 132, the display circuitry 134, and other peripheral devices 138 is communicatively coupled to the chipset 112 via signal paths 124. Again, similar to the signal paths 120, the signal paths 124 may be embodied as any type of signal paths capable of facilitating communication between the chipset 112 and the communication circuitry 130, the data storage 132, the display circuitry 134, and other peripheral devices 138 such as, for example, any number of bus paths, printed circuit board traces, wires, vias, intervening devices, and/or other interconnects.

The data storage device(s) 132 may be embodied as any type of devices configured for the short-term or long-term storage of data such as, for example, memory devices and circuits, memory cards, hard disk drives, solid-state drives, or other data storage devices. The display circuitry 134 may be embodied as any number of circuits and devices for controlling a display 136 of the computing device 102. The display 136 may be embodied as, or otherwise include, any type of display device for displaying data to a user of the computing device 102 such as, for example, a liquid crystal display (LCD), a cathode-ray tube (CRT) display, a light emitting diode (LED) display, or other display device. The peripheral devices 138 may include any number of additional peripheral devices including input devices, output devices, and other interface devices. For example, the peripheral devices 138 may include a keyboard and/or mouse for supplying an input to the computing device 102. The particular number and type of devices included in the peripheral devices 138 may depend upon, for example, the intended use of the computing device 102.

The computing device 102 also includes an advertisement enforcement module 150, which may be embodied as a plurality of components including hardware components, firmware components, and software components that interact cooperatively to provide an amount of security for displaying digital content, such as digital advertisements, on the computing device 102. As such, the advertisement enforcement module 150 may include a dedicated hardware processor (e.g., an out-of-band processor) and/or other circuitry separate from the processor 110 of the computing device 102. Additionally, the advertisement enforcement module 150 may include firmware instructions configured to initialize or otherwise “boot” the advertisement enforcement module 150 in a secured environment. In some embodiments, the advertisement enforcement module 150 may be communicatively coupled to the memory device 114 via a plurality of signal paths 152 and to the communication circuitry 130 via a plurality of signal paths 154. Similar to the signal paths 120, the signal paths 152, 154 may be embodied as any type of signal paths capable of facilitating communication between the advertisement enforcement module 150 and the memory device 114 and the communication circuitry 130, respectively, such as any number of bus paths, printed circuit board traces, wires, vias, intervening devices, and/or other interconnects. Additionally, in some embodiments, the advertisement enforcement module 150 has access to reserved or otherwise secured memory locations of the memory 114.

In some illustrative embodiments, the advertisement enforcement module 150 may be implemented using Intel® Active Management Technology (Intel® AMT), using a portion of Intel® AMT, or using an Intel® Management Engine (Intel® ME), all available from Intel Corporation of Santa Clara, Calif., and/or within chipsets sold by Intel Corporation. Intel AMT® embedded platform technology enables out-of-band access to hardware and software information stored in non-volatile memory on each endpoint device, eliminating the need for a functioning operating system and many of the software agents found in other management tools.

The digital content provider server 104 may be embodied as any type of server computing device configured to perform the functions described herein. In the illustrative embodiment, the digital content provider server 104 includes a processor 180, a memory device 182, and communication circuitry 184. The processor 180 may be embodied as one or more single- or multi-core processors having any number of processor cores. The memory 182 may be embodied as one or more memory devices or data storage locations including, for example, dynamic random access memory devices (DRAM), synchronous dynamic random access memory devices (SDRAM), double-data rate synchronous dynamic random access memory device (DDR SDRAM), and/or other volatile memory devices. The communication circuitry 184 may be embodied as any number of devices and circuitry for enabling communications between the digital content provider server 104 and the computing device 102 over the network 106. For example, the communication circuitry 184 may be embodied as one or more wired or wireless network interface cards (NICs) or other network communication cards, modules, or circuits for communicating with the computing device 102 and other remote computing devices (not shown) over the network 106.

The digital content provider server 104 may also include or otherwise be communicatively coupled to a database 186. Digital content, such as digital advertisements, is stored in the database 186. The database 186 may be embodied as data stored in a suitable data structure and location such as, for example, a relational database, a flat file database, or data stored in the memory 182. As discussed in more detail below, the digital content provider server 104 is configured to maintain digital advertisements and/or other digital content in the database 186, transmit the digital advertisements to the computing device 102 for display thereon, and cooperate with the computing device 102 to verify that the advertisement(s) or other digital content is being properly displayed on the computing device 102.

In use, the computing device 102 is configured to receive advertisement(s) and/or other digital content from the digital content provider server 104 over the network 106. In one particular embodiment, the digital advertisement is encrypted by the server 104 and subsequently decrypted by the computing device 102 to ensure the validity of the advertisement. The advertisement is displayed on the computing device 102 in a pre-allocated advertisement display space of the display 136. As discussed in more detail below, the computing device 102 performs a number of security procedures to verify that the advertisement is being properly displayed and/or has otherwise not been tampered with or altered. Such security procedures may include communicating with the digital content provider server 104. If an advertisement security event occurs, which indicates that the advertisement is not being displayed properly, has been tampered with or altered, or is otherwise not functioning as intended; the advertisement enforcement module 150 is configured to respond to the advertisement security event based on an advertisement enforcement policy. For example, the advertisement enforcement module 150 may cause the computing device 102 to shut down, to reboot, to display a notification to the user, to transmit notification of the advertisement security event to the digital content provider server 104, and/or otherwise limit the user's access or use of the computing device 102 until the security event is resolved (e.g., the user pays a monthly subscription fee).

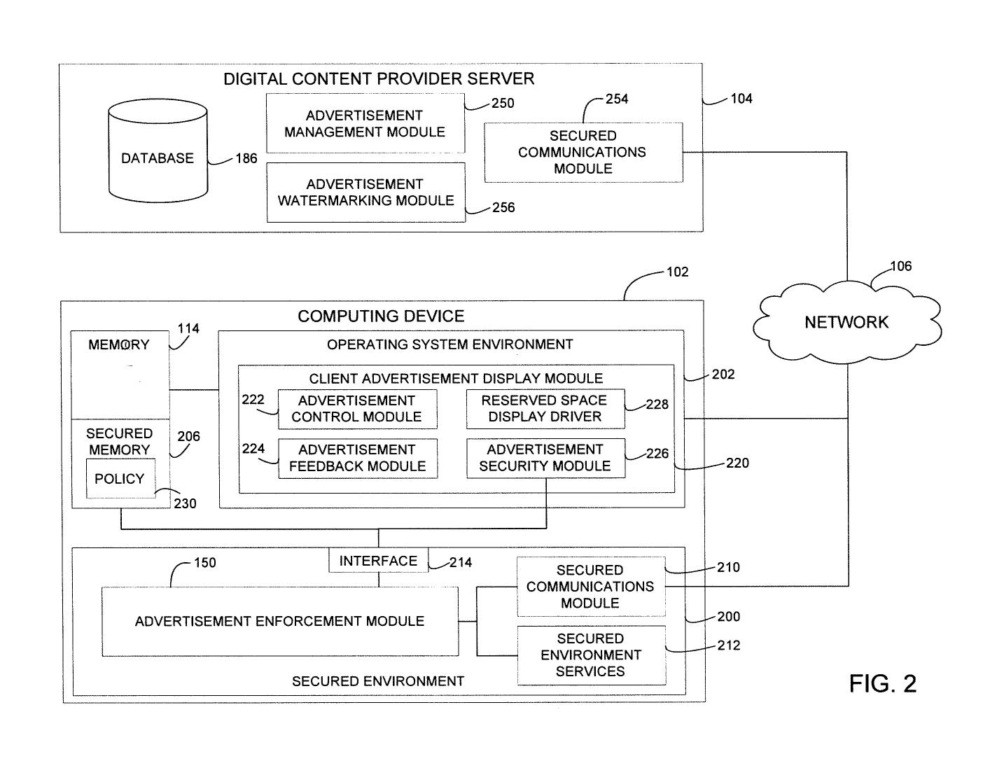

Referring now to FIG. 2, in use, each of the computing device 102 and the digital content provider server 104 includes a plurality of software modules, applications, and/or programs to facilitate the secure display of digital content, such as digital advertisements, on the computing device 102. As discussed above, the advertisement enforcement module 150 may be embodied as hardware, firmware, and/or software modules and devices. In the illustrative embodiment, the advertisement enforcement module 150 is established in a secured environment 200 of the computing device 102. As discussed above, the secured environment 200 is implemented using Intel® Active Management Technology (Intel® AMT) in the illustrative embodiment, but may be implemented using other secured environment technologies in other embodiments. The secured environment 200 is separated from and operates independently of an operating system environment 202 of the computing device, which may be unsecured. Additionally, the advertisement enforcement module 150 may be coupled to a secured memory portion 206 of the memory 114. An advertisement enforcement policy 230 may be stored in the secured memory portion 206 along with other data, such as encryption keys, used by the advertisement enforcement module 150.

The operating system, and software modules or programs being executed in the operating system environment 202, may communicate with the advertisement enforcement module 150 via an interface 214, such as an application program interface (API). In embodiments in which the secured environment 200 is implemented using Intel® Active Management Technology (Intel® AMT), the interface 214 may be embodied as a Host Embedded Controller Interface (HECI), which is well-known in the art and allows bi-directional communication between the operating system environment 202 and the secured environment 200.

The secured environment 200 also includes a secured communications module 210, which may be configured to receive out-of-band communications from the digital content provider server 104. The secured communications module 210 may be configured to encrypt/decrypt communications with the digital content provider server 104. Additionally, the secured communications module 210 may utilize the communication circuitry 130 of the computing device 102 as discussed above in regard to FIG. 1. Additionally, other secured environment services 212 may be available in the secured environment 200 including cryptographic services, protected timers, and other secured services that may be used by the advertisement enforcement module 150 to verify the secure display of digital content on the computing device 102 as discussed in more detail below.

The computing device 102 also includes a client advertisement display module 220, which is established in the operating system environment 202. The client advertisement display module 220 controls the displaying of digital content, such as digital advertisements, received from the digital content provider server 104 and cooperates with the advertisement enforcement module 150 to ensure the security of the displayed advertisements. In some embodiments, the advertisement enforcement module 150 is responsible for initiating the client advertisement display module 220 as discussed below.

The client advertisement display module 220 includes a plurality of software modules as illustrated in FIG. 2. In the illustrative embodiment, the client advertisement display module 220 includes an advertisement control module 222, an advertisement feedback module 224, a reserved space display driver 228, and an advertisement security module 226. However, in other embodiments, additional or fewer modules may be utilized by the client advertisement display module 220. Additionally, it should be appreciated that such additional modules may be incorporated in the client advertisement display module 220 or may be separate therefrom but interfaced with the module 220.

The advertisement control module 222 is configured to display the advertisements received from the digital content provider server 104 and maintain user advertisement preferences regarding such advertisements. In some embodiments, the advertisement control module 222 is configured to determine the user's preferences directly. For example, the user may provide preference data via a user interface on which advertisements may be selected such as products or services of interest, store location, and the like. Additionally or alternatively, the advertisement control module 222 may be configured to determine the user's preferences indirectly based on, for example, historical data and/or aspects of the advertisements previously selected by the user. The advertisement control module 222 may store the user preferences in the memory 114. The advertisement control module 222 is configured to transmit periodically, occasionally, or in response to an interrogation communication, the user preference data to the digital content provider server 104. In response, the digital content provider server 104 selects and transmits advertisements or other digital content to the computing device 102 based on the user preferences received from the advertisement control module 222 (i.e., received from the computing device 102). In some embodiments, the advertisement control module 222 may be protected by tamper resistant software (TRS) technology or other software protection methodologies.

The advertisement feedback module 224 is configured to monitor the user's interaction with the advertisements and/or the advertisement reserved display space of the display 136 in which the advertisements are displayed. For example, the advertisement feedback module 224 may monitor the number of times a user “clicks” on the advertisement and/or advertisement reserved display space. The advertisement feedback module 224 is configured to transmit periodically, occasionally, or in response to an interrogation communication, data indicative of the user's interaction with the advertisement and/or advertisement reserved display space to the digital content provider server 104 for statistical analysis (e.g., for detecting click fraud).

The advertisement security module 226 is configured to cooperate with the advertisement enforcement module 150 to verify that advertisements received from the digital content provider server 104 are being properly displayed on the computing device 102. In one embodiment, the advertisement security module 226 is configured to communicate periodically with the advertisement enforcement module 150 to notify the module 150 that client advertisement display module 220 is operating correctly. Accordingly, if the advertisement enforcement module 150 does not receive a “heart beat” communication from the advertisement security module 226 within a predefined time interval or in response to an interrogation, the advertisement enforcement module 150 may determine that an advertisement security event has occurred and respond accordingly.

Additionally, in some embodiments, the advertisement security module 226 is configured to generate periodically, occasionally, or in response to an interrogation communication, a screen capture of the display 136 of the computing device 102 and transmit the screen capture to the digital content provider server 104 for analysis (e.g., analysis of watermarking on the advertisements). However, in other embodiments, the advertisement enforcement module 150 may perform the screen capturing functions. Similar to the advertisement control module 222, the advertisement security module 226 may be protected by tamper resistant software (TRS) technology or other software protection methodologies.

The reserved space display driver 228 is configured to allocate a portion of the display space of the computing device 102 for advertisements and control the display of the main content, which is displayed in the remaining display space. In embodiments wherein the computing device 102 includes a single display 136, the reserved space display driver 228 is configured to allocate a portion of the display space of the display 136. However, in embodiments in which the computing device 102 has multiple displays 136 (e.g., a secondary external monitor connected to a laptop computer, dual monitors connected to a desktop computer, etc.), the reserved space display driver 228 may be configured to allocate a portion of the display space of only one of the displays 136, multiple displays 136, or all of the displays 136.

In some embodiments, the reserved space display driver 228 allocates a particular amount of the top, bottom, or sides of display space of the computing device 102 as the advertisement reserved display space in which the advertisements are displayed. Additionally, the main content space is moved accordingly. In one particular embodiment, the reserved space display driver 228 allocates 5-10% of the top, bottom, left side, and/or right side of the display space of the computing device 102 as reserved space for advertisement. Of course, in other embodiments, the reserved space display driver 228 may be configured to allocate more or less space for the advertisements. Additionally, in some embodiments, the reserved space display driver 228 may allow a user of the computing device 102 to reposition the reserved advertisement space. In such embodiments, the reserved space display driver 228 is configured to adjust the placement of the main content display space in response to the new position of the reserved advertisement display space. The reserved space display driver 228 is also configured to resize the main content to fit into the newly sized main content display space. Additionally, in embodiments wherein the advertisements are not pre-sized for display in the advertisement reserved display space, the reserved space display driver 228 may also be configured to re-size the advertisements accordingly.

The digital content provider server 104 may also include a plurality of software modules as illustrated in FIG. 2. In the illustrative embodiment, the digital content provider server 104 includes an advertisement management module 250, an advertisement watermarking module 256, and a secured communications module 254 similar to the secured communications module 210 of the computing device 102. The advertisement management module 250 manages the digital advertisements and other digital content stored in the database 186. Additionally, the advertisement management module 250 is configured to select advertisements to transmit to the computing device 102. The advertisement management module 250 may select such advertisements based on, for example, the user preferences received from the computing device 102.

The advertisement watermarking module 256 is configured to apply a digital watermark to each advertisement transmitted to the computing device 102 for display. To do so, the advertisement watermarking module may use any suitable digital watermarking algorithm. The advertisement watermarking module 256 is also configured to verify the presence of a watermark on the advertisements included in the screen captures received from the advertisement security module 226 and/or the advertisement enforcement module 150 to ensure that the proper advertisement is being displayed on the computing device 102. If the advertisement does not include the earlier applied watermark, the advertisement enforcement module 150 may determine a security event has occurred and notify the computing device 102 accordingly.

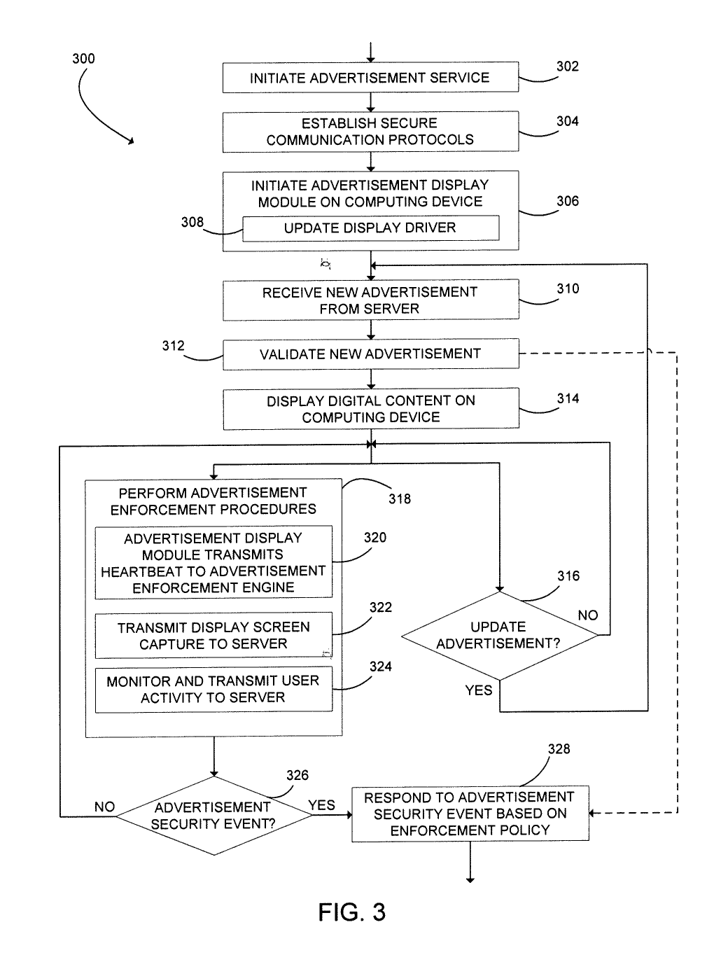

Referring now to FIG. 3, a method 300 for securely displaying digital content may be executed by the computing device 102. The method 300 begins with block 302 in which the advertisement service on the computing device 102 is initiated. In some embodiments, the advertisement service may be initiated by the user of the computing device 102 (e.g., by signing a subscription agreement) or autonomously when the computing device 102 is first powered-on by the user.

In block 304, the computing device 102 and the digital content provider server 104 communicate with each other to establish secure communication protocols. For example, the device 102 and server 104 may establish the encryption methodology to be used between each and/or otherwise set up a secure communication channel between the secured communications modules 210, 254.

In block 306, the client advertisement display module 220 is initiated in the operating system environment 202 of the computing device 102. In some embodiments, the advertisement enforcement module 150 is configured to initiate the client advertisement display module 220. In other embodiments, the client advertisement display module 220 may be downloaded from the digital content provider server 104. Additionally, in block 308, the computing device 102 may update the reserved space display driver 228 by communicating with the digital content provider server 104. Such updates may define, for example, the size of the advertisement reserved display space and/or other data used by the reserved space display driver 228.

The computing device 102 receives a new advertisement from the digital content provider server 104 in block 310. As discussed above, the digital content provider server 104 may select the advertisement to be displayed based on user preferences or other criteria. In the illustrative embodiment, the advertisement is encrypted by the digital content provider server 104 and includes a digital watermark placed on the advertisement by the digital content provider server 104. In block 312, the advertisement enforcement module 150 validates the advertisement by decrypting the advertisement using the encryption methodology established in block 304. In this way, the computing device 102 can determine the validity of the advertisement based on whether it can properly decrypt the advertisement. If the computing device 102 cannot validate the advertisement, the computing device 102 may be configured to determine that an advertisement security event has occurred; and the method 300 proceeds to block 328. In other embodiments, the method may loop back to block 310 to receive a new advertisement.

If the advertisement is determined to be valid in block 312, the digital advertisement is displayed in the advertisement reserved display space of the display 136 of the computing device 102 in block 314. To do so, the computing device 102 may execute a method 400 to allocate the advertisement reserved display space and configure the advertisement for display. The reserved space display driver 228 may be initiated autonomously in some embodiments. Alternatively, in other embodiments, a trusted software agent, which may be located on the computing device 102 or the digital content provider server 104, may initiate the reserved space display driver 228. The trusted software agent may also reposition the advertisement reserved display space dynamically at any time. Additionally, the advertisement reserved display space may be dynamically created or removed at various times depending on the particular implementation. For example, the advertisement reserved display space may be created prior or subsequent to the booting of an operating system of the computing device 102, upon receipt of the first advertisement from the digital content provider server, or in response to instructions received from a trusted software agent as discussed above.

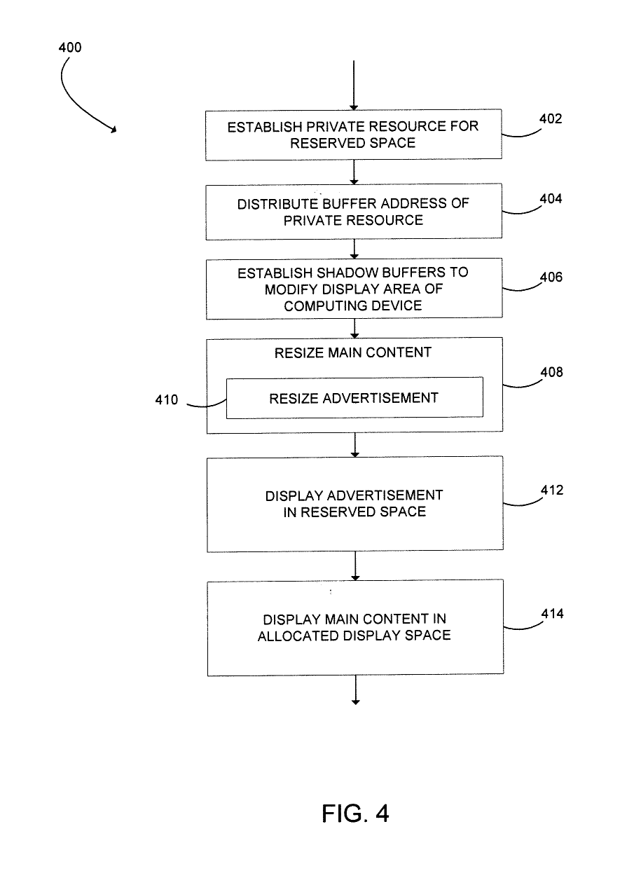

As illustrated in FIG. 4, the method 400 begins with block 402 in which the reserved space display driver 228 establishes a private resource for the advertisement reserved display space. The buffer address of the private resource is distributed to other modules of the client advertisement display module 220, to the advertisement enforcement module 150, and, in some embodiments, to the digital content provider server 104 in block 404. Additionally, the reserved space display driver 228 establishes one or more shadow buffers in block 406 to modify the display area of the display 136. In particular, the reserved space display driver 228 establishes the advertisement reserved display space and the main content display space in block 406. As discussed above, in one particular embodiment, the advertisement reserved display space is embodied as the top or bottom 5% of the overall display space of the display 136, while the main content display space is embodied as the remaining space.

In block 408, the reserved space display driver 228 resizes the main content that is to be displayed on the display 136. The main content, such as web pages, documents, and other files, is resized to fit within the main content display space such that none of the main content block or otherwise overlaps the reserved advertisement space allocated by the reserved space display driver 228. Additionally, in some embodiments, the reserved space display driver 228 may also resize the advertisement to fit within the advertisement reserved display space if the advertisement is not pre-sized by the digital content provider server 104 (block 410). The advertisement is subsequently displayed to the user in block 412 in the advertisement reserved display space. Additionally, the main content is displayed in the main content display space in block 414. The method 400 may be executed for each new advertisement (e.g., in embodiments wherein the size of the advertisement reversed display space varies) or only once upon activation of the subsidized services. It should be appreciated that the reserved advertisement space is only allocated when the user is using the subsidized services. As such, when the subsidized service is not being used, the user has access to the full area of the display space.

Referring back to FIG. 3, after the new advertisement has been displayed on the computing device 102, the method 300 advances to blocks 316 and 318, which may be executed contemporaneously with each other. In block 316, the computing device 102 determines whether to update the advertisement currently being displayed. Such updating may be performed periodically or in response to receiving communication from the digital content provider server 104. If so, the method 300 loops to block 310 in which a new advertisement is received from the server 104.

In block 318, the computing device 102 may perform one or more advertisement enforcement procedures to ensure and verify that the advertisement is being properly displayed on the computing device 102. For example, in block 320, the client advertisement display module 220 may be configured to transmit a “heart beat” communication to the advertisement enforcement module 150 to ensure the client advertisement display module 220 is operating properly. Such “heart beat” transmissions may be periodic or in response to an interrogation communication by the advertisement enforcement module 150. The advertisement enforcement module 150 may be configured to determine the occurrence of an advertisement security event (i.e., the advertisement is not being displayed properly) if a “heart beat” communication is not received within the predefined time period or in response to the interrogation communication from the advertisement enforcement module 150.

Additionally, in block 322, the client advertisement display module 220 may be configured to periodically or upon command generate a screen capture of the display 136. The screen capture data is provided to the advertisement enforcement module 150, which encrypts the screen capture data and securely transmits the data to the digital content provider server 104 for analysis. In particular, the advertisement watermarking module 256 of the server 104 analyzes the screen capture data to ensure that advertisement includes the pre-applied watermark. If not, the server 104 may be configured to notify the advertisement enforcement module 150 that an advertisement security event has occurred because the advertisement is fraudulent in some manner.

In block 324, the client advertisement display module 220 and/or the advertisement enforcement module 150 may monitor the user's activity and/or interaction with the displayed advertisement and/or the advertisement reserved display space. Data indicative of such interaction may be transmitted to the digital content provider server 104 for further analysis to, for example, determine whether “click fraud” is occurring, the user is attempting to circumvent the advertisement display, etc. As with the screen capture data, the data indicative of the user's interaction and activities may be encrypted by the advertisement enforcement module 150 prior to transmission to the digital content provider server 104.

In block 326, the computing device 102 determines whether an advertisement security event has occurred based on one or more of the advertisement enforcement procedures performed in block 318. If no advertisement security event has occurred, the method 300 loops back to blocks 316 and 318. However, if the computing device 102 determines that an advertisement event has occurred, the method 300 advances to block 328 in which the computing device 102 (i.e., the advertisement enforcement module 150) responds to the event based on the advertisement enforcement policy 230. The advertisement enforcement module 150 may perform any action in response to the advertisement security event including, for example, causing the computing device 102 to shutdown or reboot, displaying a notification to the user of the device 102 regarding the advertisement security event, interrupting or otherwise shutting down network communications of the computing device 102 (except for secured communications to the server 104), and/or otherwise reducing the user's control of the computing device 102 (e.g., limiting the applications that may be executed, limiting the web sites that may be visited, etc.). Once the advertisement security event is properly acknowledged and dealt with by the user (e.g., the user pays a past due subscription fee), the computing device 102 may restore normal functionality including the displaying of digital content received from the digital content provider server 104.

It should be appreciated that although the system 100 has been described above in regard to the secure display of advertisements, the system 100 and computing device 102 may be used to securely display other types of digital content in a similar manner. For example, in some embodiments, news information may be displayed in the reserved display space. Additionally, in some embodiments, data feeds from online websites or other data sources (e.g., a Really Simple Syndication (RSS) feed) may be displayed in the reserved display space. As such, the digital content provider server 104 may transmit any type of digital content to the computing device 102 for secure display on the device 102 as discussed in detail above.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

1. A method comprising:
establishing an advertisement display module and an advertisement enforcement module on a computing device;
allocating an advertisement reserved display space on a display of the computing device;
establishing a trust relationship between a computing device and a trusted advertisement provider server;
receiving an advertisement from the trusted advertisement provider server with the advertisement enforcement module;
validating the advertisement with the advertisement enforcement module;
displaying the advertisement in the advertisement reserved display space using the advertisement display module in response to the advertisement being validated; and
verifying that the advertisement is being displayed on the computing device.

2. The method of claim 1, wherein establishing the advertisement enforcement module comprises establishing the advertisement enforcement module in a secured boot environment.

3. The method of claim 1, wherein establishing the advertisement enforcement module comprises executing the advertisement enforcement module on an out-of-band processor of the computing device.

4. The method of claim 1, wherein receiving the advertisement from the advertisement provider server comprises receiving an advertisement including a digital watermark, the digital watermark being generated by the advertisement provider server.

5. The method of claim 1, wherein receiving the advertisement from the advertisement provider server comprises receiving an encrypted advertisement, the encrypted advertisement being encrypted by the advertisement provider server.

6. The method of claim 5, wherein validating the advertisement comprises decrypting the encrypted advertisement using the advertisement enforcement module.

7. The method of claim 1, wherein:
displaying the advertisement in the advertisement reserved display space comprises moving advertisement reserved display space from a first position to a second position, and
verifying the advertisement comprises verifying that the advertisement reserved display space is visible in the second position.

8. The method of claim 1, wherein displaying the advertisement comprises re-sizing the advertisement based on a size of the advertisement reserved display space.

9. The method of claim 1, wherein verifying that the advertisement is being displayed comprises:
periodically transmitting a communication from the advertisement display module to the advertisement enforcement module; and
determining an occurrence of an advertisement security event if the communication is not received by the advertisement enforcement module within a predetermined time period.

10. The method of claim 1, wherein verifying that the advertisement is being displayed comprises:
generating a screen capture of a display of the computing device; and
transmitting to the advertisement provider server at least one of (i) the screen capture and (ii) a pattern signature generated from the screen capture.

11. The method of claim 10, wherein transmitting the screen capture comprises encrypting the at least one of (i) the screen capture and (ii) the pattern signature using the advertisement enforcement module.

12. The method of claim 1, wherein verifying that the advertisement is being displayed comprises:
generating data indicative of a user's activity on the computing device;
encrypting the data using the advertisement enforcement module; and
transmitting the encrypted data to the advertisement provider server.

13. The method of claim 1, wherein verifying that the advertisement is being displayed comprises:
monitoring, on the computing device, a user's interaction with the advertisement; and
transmitting data indicative of the user's interaction with the advertisement to the advertisement provider server.

14. The method of claim 1, wherein verifying that the advertisement is being displayed comprises:
receiving, on the computing device, notification from the advertisement provider server of an advertisement security event; and
responding to the advertisement security event with the advertisement enforcement module.

15. The method of claim 1, wherein verifying that the advertisement is being displayed comprises:
determining an occurrence of an advertisement security event; and
responding to the advertisement security event with the advertisement enforcement module, wherein responding to the advertisement security event comprises performing at least one of the following actions: rebooting the computing device, notifying a user of the computing device, interrupting network communications of the computing device, and reducing a user's control of the computing device.

16. A tangible, machine readable medium comprising a plurality of instructions that, in response to being executed, result in a computing device:
establishing a reserved display space on a display of the computing device;
receiving digital content from a digital content provider server;
displaying the digital content on the computing device in the reserved display space;
generating data indicative of a user's interaction with the reserved display space; and
transmitting the data indicative of the user's interaction to the digital content provider server.

17. The tangible, machine readable medium of claim 16, wherein generating data indicative of a user's interaction with the reserved display space comprises monitoring the user's selection of the digital content displayed in the advertisement reserved display space.

18. The tangible, machine readable medium of claim 16, wherein the plurality of instructions further result in the computing device encrypting data indicative of the user's interaction with the reserved display space.

19. A computing device comprising:
a display having a display space
a digital content enforcement module;
a processor; and
a memory device having stored therein a plurality of instructions, which when executed by the processor, cause the digital content enforcement module to:
receive digital content from a remote computing device;
validate the digital content to cause the digital content to be displayed on the display in a pre-allocated display space less than the entirety of the display space; and
verify that the digital content is being displayed on the computing device within the pre-allocated display area.

20. The computing device of claim 19, wherein the plurality of instructions further cause the digital content enforcement module to record a user's interaction with the digital content displayed in the pre-allocate display space.
